(19) United States
(12) Patent Application Publication
(10) Pub. No.: US 2026/0208644 A1
(43) Pub. Date: Jul. 23, 2026

(54) CUSHION OBTAINED BY 3D PRINTING

(71) Applicants: COMMISSARIAT A L'ENERGIE ATOMIQUE ET AUX ENERGIES ALTERNATIVES - CEA, PARIS (FR); RENAULT S.A.S., BOULOGNE-BILLANCOURT (FR)

(72) Inventors: Michael BOUVIER, Grenoble (FR); Eric BRIN, GUYANCOURT (FR); Hervé GLEYZES, Grenoble (FR); Jean-Baptiste ROY, GUYANCOURT (FR)

(21) Appl. No.: 19/142,384

(22) PCT Filed: Dec. 21, 2023
(86) PCT No.: PCT/FR2023/052088

§ 371 Date: Jun. 23, 2025

(30) Foreign Application Priority Data
Dec. 21, 2022 (FR) FR2214159

(51) Int. Cl. B60N 2/70; B33Y 80/00; B60N 2/64

(52) U.S. Cl. CPC B60N 2/7017; B60N 2/646; B33Y 80/00

(57) ABSTRACT

A monolithic cushion (100) includes at least three separate layers (101, 104, 106), a front contact layer (101) having a single layer forming a grid with a plurality of solid unit cells (102) connected together by front arms (140), and an intermediate layer (104) with a single layer having a grid with a plurality of hollow unit cells (105) connected together by arms that leave free spaces between the hollow unit cells (105). The intermediate layer (104) is in contact with the front layer (101). A rear comfort layer (106) forms the core of the cushion (100) and having a stack with at least two layers of openwork cells (107), the rear layer (106) being in contact with the intermediate layer (104).

The present invention relates to a cushion obtained by 3D printing.

Such a cushion is particularly but not exclusively suitable for a vehicle seat. In general, a vehicle seat comprises a seat base and a backrest. In some cases, such as in racing vehicles intended to be driven on a circuit, the geometry of this seat base and backrest can appear complex, in particular by having different inclined walls intended to keep the driver's body in the most stable position possible on his seat. In order to improve the comfort and support of these drivers, flexible cushions made, for example, of foam and surrounded by a fabric envelope are attached to the various walls making up said backrest and said seat base.

However, current manufacturing techniques for these cushions lack a great deal of flexibility, as they take a long time to develop and are difficult to customize (they are only designed for a single seat type and one user profile). Indeed, it takes just a slight change in the shape and/or dimensions of the seat for these techniques to no longer be suitable. The various pieces of equipment used in these techniques must then be modified to obtain the desired product, with the right geometry and dimensions. These modifications to the equipment which are time-consuming to carry out, require modifications or the creation of specific tooling, and therefore generate additional costs and delays.

To overcome all these disadvantages, a current trend is to manufacture these cushions using 3D printing, which is a simple, automated and fast manufacturing technique. More specifically, it is sufficient to design the product and program the characteristics of the different layers to be placed in the cushion into the 3D printer, in order to obtain a cushion with the desired properties. It is important to remember that a major advantage of parametric design for 3D printing is that the object to be manufactured, in this case a cushion, is produced continuously and in a single operation from one end to the other, without having to manufacture the various components of the object separately and then assemble them in the desired manner. With 3D printing, depending on the volumes and quantities produced, the time and cost of assembling an equivalent product manufactured in the usual way can be considerably reduced.

A cushion according to the invention is obtained using 3D printing, while offering comfort and support qualities at least equivalent to those of cushions obtained using conventional manufacturing techniques.

One object of the invention is a monolithic cushion.

According to the invention, the cushion comprises at least three separate layers:
a front contact layer having a single layer forming a grid with a plurality of solid unit cells, connected together by arms that leave free spaces between said solid unit cells, and
a soft intermediate layer having a single layer having a grid with a plurality of hollow unit cells, connected together by arms that leave free spaces between said hollow unit cells, said intermediate layer being in contact with the front layer, such that each solid unit cell matches with and abuts against a hollow unit cell, and
a rear comfort layer forming the core of the cushion and comprising a stack of at least two layers of openwork cells, said rear layer being in contact with the intermediate layer such that said intermediate layer is between the front layer and the rear layer.

Schematically, the front contact layer is intended to come into contact with a person, instead of the usual textile, and the intermediate and rear layers ensure the overall mechanical behavior (including comfort) of said cushion, the intermediate layer constituting a fastening layer for the front layer. The presence of solid unit cells in the front layer is justified because it is these cells that will come into contact with a part of an individual's body. They must therefore have a certain softness to the touch, unlike hollow cells which are less pleasant to the touch. Advantageously, the grid of the front layer is substantially flat. The softness of the cushion is provided by the intermediate layer and the rear layer, with the intermediate layer providing the transition between the front layer and the rear layer. The fact that a hollow cell in the intermediate layer matches and contacts a solid cell in the front layer ensures stable contact between said two layers and therefore prevents relative slippage between said two layers as soon as a part of a person's body comes into contact with said front layer. The number of layers making up the rear layer depends on the thickness and deformation properties desired for the cushion. The three layers making up the cushion may be flat, or have at least one fold so as to present two consecutive sections that are inclined with respect to one another. Preferably, the thicknesses of the front and intermediate layers are less than 1 cm, and even more advantageously less than 0.5 cm. The rear layer can be several centimeters thick. Advantageously, the three layers making up the cushion have contours of the same dimensions. The three constituent layers of the cushion each have a maximum number of passages and openings to lighten the cushion, and to ensure that the cushion is dust-free at the end of manufacture and to ensure a final color finish or other treatment. The openings between the layers advantageously have a passive ventilation capacity greater than that of a conventional car seat. The term “monolithic” attributed to the cushion means that the cushion is manufactured from a single material using a single process.

According to one possible feature of the invention, the solid unit cells of the front layer have a quadrilateral shape.

According to one possible feature of the invention, the solid unit cells of the front layer each have a central opening. The central openings contribute to making the cushion a little lighter and to facilitating the removal of dust at the end of manufacture of the cushion.

According to one possible feature of the invention, the hollow unit cells of the intermediate layer are elliptical and have dimensions smaller than or equal to those of the solid unit cells of the front layer. This interaction between the cells ensures a good continuum between the front layer and the intermediate layer without the risk of causing relative slippage between the two layers when part of an individual's body comes into contact with the cushion.

According to one possible feature of the invention, the rear comfort layer comprises openwork cells in the shape of a truncated octahedron, or corresponding to the desired mechanical behavior. This type of cell gives the rear layer a good ability to deform, thereby increasing the comfort of the cushion.

According to one possible feature of the invention, the rear comfort layer comprises a first face which is in contact with the soft intermediate layer and a second face which is substantially parallel to said first face and which is intended to come into contact with an outer surface, said second face having material protrusions in order to increase the contact surface between the cushion and said outer surface. The sole purpose of these material protrusions is to increase the contact surface between the cushion and an outer surface to which said cushion is intended to be attached. This outer surface may, for example, be a seat base or backrest surface of a car seat. These material protrusions emerge very moderately from the second face of the rear layer of the cushion so as not to enlarge, or to enlarge by less than 1%, the dimensions of the cushion. These protrusions can be replaced by a solid, continuous surface. On the other hand, said protrusions have an advantageously lighter construction than this solid surface solution, and enable better dust removal from the cushion after production.

According to one possible feature of the invention, the second face has a hollow groove delimited by a continuous wall and intended for the insertion of a fastening material. The fastening material may, for example, consist of an adhesive or a Velcro-type material. Advantageously, this groove forms a closed loop, and even more advantageously a rectangular loop. This groove extends in a peripheral region of the cushion. According to a variant of the invention, the groove may be designed discontinuously, in relation to the desired fastening zones.

According to one possible feature of the invention, the front contact layer, the soft intermediate layer and the rear comfort layer have contours of the same dimensions, the cushion comprising a support layer in the form of a lateral strip surrounding the three stacked layers constituting the cushion, the width of said strip corresponding to the stacked height of said three constituent layers of said cushion. This support layer helps to give the cushion a good overall hold, and to limit potential accidental extensions of the three constituent layers of the cushion inside said cushion 100. These extensions are inherent in the manufacture of the cushion and are not sought. The support layer retains these extensions in order to make the cushion softer to the touch.

According to one possible feature of the invention, the support layer consists of a plurality of meshes. Preferably, these meshes are diamond-shaped or elliptical. These meshes delimit openings and help to lighten the cushion compared to a solid, continuous support layer. These openings also help to improve dust removal from the assembly after manufacture.

Lastly, manufacturing all these layers using the same process, without any assembly, is more environmentally friendly, particularly for recycling the whole cushion.

According to one possible feature of the invention, the front arms connecting the solid unit cells of the front layer are not rectilinear and have a curvature or at least one fold, so as to be able to deploy when said front layer is deformed. In this way, when the front layer deforms under the effect, for example, of a person sitting on the cushion, the arms can accompany this deformation by deploying. When the arms deploy, they tend to adopt a rectilinear profile. These front arms give flexibility to the front layer, in particular in the plane containing the solid unit cells.

Another object of the invention is a vehicle seat comprising a seat base and a backrest.

According to the invention, at least one cushion conforming to the invention is fixed to said seat base and to said backrest. The cushions according to the invention have been developed to be advantageously fixed to a vehicle seat, in particular to a sports vehicle bucket seat.

Another object of the invention is a vehicle comprising at least one seat conforming to the invention.

A cushion according to the invention has the advantage of being able to be manufactured quickly, automatically and accurately, while at the same time having the properties required to ensure good comfort and support for an individual, who would be sitting, for example, on a vehicle seat to which said cushion has been previously attached. It also has the advantage of being able to be manufactured in a wide range of materials, or even multiple materials, using 3D printing, and therefore to have varied or even novel structural features, suitable for the materials used. Such a cushion also has the advantage of being able to appear with varied patterns and colors, depending on the materials used in the 3D printing, making it possible, for example, to improve the visual rendering of the interior of a vehicle if said cushion was fixed to a seat of said vehicle.

A detailed description of a preferred embodiment of a cushion according to the invention is given below with reference to the following figures, in which:

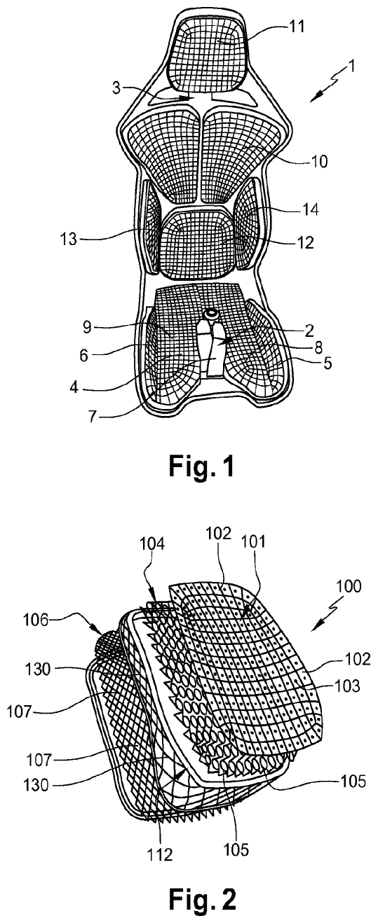

FIG. 1 is a perspective view of a vehicle seat comprising a plurality of cushions according to the invention,

FIG. 2 is an exploded view of a first embodiment of a cushion according to the invention,

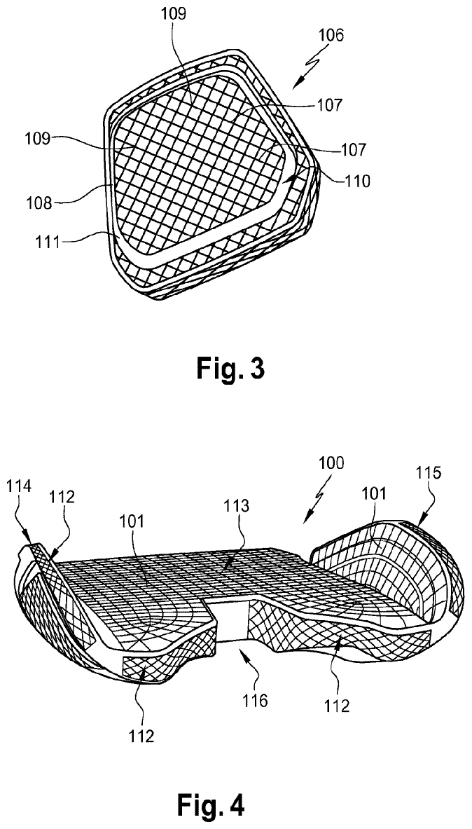

FIG. 3 is a perspective view of a rear layer of the first embodiment of a cushion according to the invention,

FIG. 4 is a perspective view of a second embodiment of a cushion according to the invention,

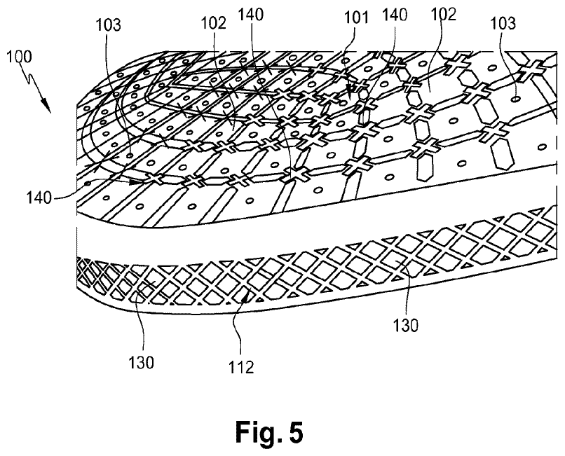

FIG. 5 is a perspective view of an area of a cushion according to the invention, showing the structural features of the front layer and the support layer.

Referring to FIG. 1, a vehicle seat 1 according to the invention is a racing vehicle seat comprising a seat base 2 and a backrest 3. This seat base 2 has a flat central section 4, substantially rectangular in shape, and two raised lateral sections 5, 6 originating on two parallel edges of the central section 4, said central section 4 having a front notch 7. The two raised lateral sections 5, 6 prevent a driver who is sitting on the central section 4 of the seat base 2 from inadvertently sliding down the sides of said seat base 2, for example when the vehicle takes a bend. The front notch 7 allows a seatbelt to be attached, and the two portions 8, 9 of the central section 4 located on either side of the notch 7 provide support for the driver's legs. The backrest 3 has a main section 10 against which the driver's back is intended to rest, a headrest 11 placed above said main section 10, and a connecting wall 12 located between the main section 10 of the backrest 3 and the central section 4 of the seat base 2. The connecting wall 12 is delimited by two inclined lateral edges 13, 14, each of said two inclined lateral edges 13, 14 being located in the extension of a raised lateral section 5, 6 of the seat base 2. In the same way as said two lateral sections 5, 6, the two inclined lateral edges 13, 14 prevent a driver who is sitting on the seat 1 resting against the backrest 3 from inadvertently sliding on the sides of said backrest 3, for example when the vehicle is taking a bend.

The special feature of the seat 1 described above is that it comprises several cushions 100 manufactured by 3D printing, also known as simultaneous additive manufacturing, said cushions 100 replacing the foam and the fabric envelope surrounding said foam of conventionally manufactured cushions, and the means of assembling or reinforcing said foam and said fabric envelope.

Referring to FIGS. 2, 3 and 5, a first embodiment of a cushion 100 according to the invention, which is manufactured by 3D printing, is intended to be fixed to the headrest 11 of the seat 1. This cushion 100 comprises four separate layers:
a front contact layer 101 having a single layer forming a substantially flat grid with a plurality of solid unit cells 102, connected together by arms that leave free spaces between said solid unit cells 102. These solid unit cells 102 have the same dimensions within said front layer 101, and are each rectangular in shape. Each of these solid unit cells 102 may have a central opening 103. Advantageously, the thickness of this front layer 101 is less than or equal to 5 mm. Referring to FIG. 5, the solid unit cells 102 of the front layer 101 are connected together by non-rectilinear front arms 140, which may for example have a curvature or at least one fold. In this way, when the front layer 101 deforms, for example under the effect of a person sitting on the cushion 100, these front arms 140 can easily accompany this deformation by deploying. When the front arms 140 are deployed, they will tend to adopt an elongated rectilinear profile and provide flexibility, in particular in the plane containing the solid unit cells, and—a soft intermediate layer 104 having a single layer forming a grid with a plurality of hollow unit cells 105, connected together by arms that leave free spaces between said hollow unit cells 105, said intermediate layer 104 being in contact with the front layer 101 in such a way that each solid unit cell 102 matches with and abuts against a hollow unit cell 105. The hollow unit cells 105 of the intermediate layer 104 are elliptical or trapezoidal in shape and have dimensions smaller than or equal to those of the solid unit cells 102 of the front contact layer 101. Preferably, the thickness of this intermediate layer 104 is less than or equal to 5 mm, and
a rear comfort layer 106 forming the core of the cushion 100 and comprising a stack of at least two layers of openwork cells 107, said rear layer 106 being in contact with the intermediate layer 104 such that said intermediate layer 104 is between the front contact layer 101 and the rear layer 106. Each of the openwork cells 107 has the shape of a truncated octahedron or corresponding to the desired mechanical behavior. Referring to FIG. 3, the rear comfort layer 106 comprises a first face which is in contact with the soft intermediate layer 104 and a second face 108 which is substantially parallel to said first face and which is intended to come into contact with a surface of the headrest 11 of the seat 1, said second face 108 having material protrusions 109 so as to increase the contact surface between the cushion 100 and the surface of said headrest 11. It is important for this second face 108 to have homogeneous mechanical strength, so that the cushion 100 does not deform in an uncontrolled manner and wear out prematurely. The sole purpose of these protrusions 109, which can take a variety of shapes, is to increase the contact surface between the second face 108 of the cushion 100 and the surface of the headrest 11. This second face 108 may reveal a hollow groove 110, delimited by a continuous wall 111 of substantially semi-cylindrical or rectangular shape and intended to house a fastening material, such as a Velcro strip, for example. This hollow groove 110 is obtained by 3D printing, preferably in the same way as the rest of the cushion 100 and therefore produced simultaneously, and does not therefore result from the insertion of a wall added in the rear layer 106. This groove 111 is closed and forms a substantially rectangular frame which is close to the peripheral edge of said rear layer 106, and
a support layer 112 of the front contact layer 101, the soft intermediate layer 104 and the rear comfort layer 106. In fact, these three layers 101, 104, 106 constituting the cushion 100 have contours of the same dimensions, said support layer 112 appearing in the form of a strip surrounding said three stacked layers 101, 104, 106. The width of this strip constituting the support layer 112 corresponds to the stacked height of the three layers 101, 104, 106 constituting the cushion 100. This support layer 112 helps to give the cushion 100 a good overall hold, and to limit potential accidental extensions of the three constituent layers 101, 104, 106 of the cushion 100 inside said cushion 100. These extensions are inherent in the manufacture of the cushion 100 and are not sought. The support layer 112 retains these extensions in order to make the cushion softer to the touch. Preferably, this support layer 112 consists of a plurality of meshes 130, each advantageously diamond-shaped.

The various layers 101, 104, 106, 112 of the cushion obtained by 3D printing each have openings, passages, orifices and free spaces with the aim of making the cushion 100 as light as possible and facilitating the removal of dust from said cushion 100 at the end of its manufacturing process by 3D printing. At the end of said process, dust remains stored in the cushion 100 and it is essential to be able to remove it simply and quickly.

Referring to FIG. 4, a second embodiment of a cushion 100 according to the invention is intended to be fixed to the seat base 2 of the seat 1. The structural features of this second embodiment are analogous to those of the first embodiment previously described, with only the general shape of the cushion 100 changing. This second embodiment illustrates the fact that a parametric design with a view to manufacture by 3D printing makes it possible to assign any type of shape to said cushion 100. This second embodiment comprises a flat central section 113, substantially rectangular in shape, and two raised lateral sections 114, 115 originating on two parallel edges of the central section 113, said central section 113 having a front notch 116. This second embodiment of a cushion 100 according to the invention is intended to be fixed to the seat base 2 of the seat 1 previously described.

At least one cushion 100 according to the invention is fixed to each component element of the seat base 2 and backrest 3 and is intended to come into contact with a part of the body of a driver sitting on said seat 1. A parametric design for 3D printing makes it possible to give each cushion 100 a shape adapted to the shape of the element of the seat against which said cushion is intended to be fixed.

A parametric design for 3D printing gives each cushion 100 a morphology and an overall mechanical response adapted to the user's morphology.

1. A monolithic cushion (100), characterized in that it comprises at least three separate layers (101, 104, 106):
a front contact layer (101) having a single layer forming a grid with a plurality of solid unit cells (102), connected together by front arms (140) that leave free spaces between said solid unit cells (102), and
an intermediate layer (104) having a single layer having a grid with a plurality of hollow unit cells (105), connected together by arms that leave free spaces between said hollow unit cells (105), said intermediate layer (104) being in contact with the front layer (101) and connected to the front layer by arms such that each solid unit cell (102) matches with and abuts against a hollow unit cell (105), and
a rear comfort layer (106) forming the core of the cushion (100) and comprising a stack of at least two layers of openwork cells (107), said rear layer (106) being in contact with the intermediate layer (104) such that said intermediate layer (104) is between the front layer (101) and the rear layer (106).

2. The cushion as claimed in claim 1, characterized in that the solid unit cells (102) of the front layer (101) have a quadrilateral shape.

3. The cushion as claimed in claim 2, characterized in that the solid unit cells (102) of the front layer (101) each have a central opening (103).

4. The cushion as claimed in either of claims 2 and 3, characterized in that the hollow unit cells (105) of the intermediate layer (104) are elliptical and have dimensions smaller than or equal to those of the solid unit cells (102) of the front layer (101).

5. The cushion as claimed in any one of claims 1 to 4, characterized in that the rear comfort layer (106) comprises openwork cells (107) in the shape of a truncated octahedron.

6. The cushion as claimed in any one of claims 1 to 5, characterized in that the rear comfort layer (106) comprises a first face which is in contact with the soft intermediate layer (104) and a second face (108) which is substantially parallel to said first face and which is intended to come into contact with an outer surface, said second face (108) having material protrusions (109) in order to increase the contact surface between the cushion (100) and said outer surface.

7. The cushion as claimed in claim 6, characterized in that the second face (108) has a hollow groove (110) delimited by a continuous wall (111) and intended for the insertion of a fastening material.

8. The cushion as claimed in any one of claims 1 to 7, characterized in that the front contact layer (101), the soft intermediate layer (104) and the rear comfort layer (106) have contours of the same dimensions, and in that the cushion (100) comprises a support layer (112) in the form of a lateral strip surrounding the three stacked layers (101, 104, 106) constituting the cushion (100), the width of said strip corresponding to the stacked height of said three constituent layers (101, 104, 106) of said cushion (100).

9. The cushion as claimed in claim 8, characterized in that the support layer (112) consists of a plurality of meshes (130).

10. The cushion as claimed in any one of claims 1 to 9, characterized in that the front arms (140) connecting the solid unit cells (102) of the front layer (101) have a curvature or at least one fold, so as to be able to deploy when said front layer (101) is deformed.

11. A vehicle seat comprising a seat base (2) and a backrest (3), characterized in that at least one cushion (100) as claimed in any one of claims 1 to 9, is fixed to said seat base (2) and to said backrest (3).

12. A vehicle comprising at least one seat as claimed in claim 11.
